(19) United States
(12) Patent Application Publication
(10) Pub. No.: US 2009/0122763 A1
(43) Pub. Date: May 14, 2009

(54) COMMUNICATION CONTROL DEVICE AND METHOD

(75) Inventor: Naoki OGUCHI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/266,029

(22) Filed: Nov. 6, 2008

(30) Foreign Application Priority Data
Nov. 9, 2007 (JP) 2007-291746

(51) Int. Cl. H04W 36/34

(52) U.S. Cl. 370/331

(57) ABSTRACT

Included are a communication control device applied to a wireless communication system 1 which establishes a wireless communication between a base station 2 and a mobile terminal 3, has: a handover control unit 9 controlling a handover process of the mobile terminal 3; and a setting unit 8 setting a period of retain time of connection information used when the mobile terminal 3 reconnects to a handover source base station 2 by interrupting the handover process, wherein the handover control unit 9, after the mobile terminal 3 has started the handover process, controls the handover process of the mobile terminal 3 so as to retain the connection information till the retain time set by the setting unit 8 elapses, and the setting unit 8 changes setting of the retain time, corresponding to a communication status between the handover source base station 2 and the mobile terminal 3.

This application claims the benefit of Japanese Patent Application No. JP2007-291746 filed on Nov. 9, 2007 in the Japanese Patent Office, the disclosure of which is herein incorporated in its entirety by reference.

### BACKGROUND

The present technology relates to a communication control device applied to a communication system which establishes a wireless connection between a base station and a mobile terminal.

Nowadays, a wireless access network supports a handover (HO) function of switching over a base station (which will hereinafter be abbreviated to BS) corresponding to a movement of a mobile terminal (which will hereinafter be abbreviated to MS) in order to enhance mobility of the MS. The handover is a function of switching over the connection destination BS (Target BS) when the MS moves to another cell across a cell (a radio wave reachable range) of the BS. Normally, the MS measures an intensity of the radio waves transmitted from a neighbor BS at all times, and takes the handover to the BS exhibiting a strong intensity of the radio waves.

### SUMMARY

FIG. 19 shows a status where the MS moves in the vicinity of a border of the cell of the BS. As shown in FIG. 19, when the MS moves along the border but in the vicinity of the border between the base stations neighboring to each other, situation called a Ping-Pong effect occurs, wherein the MS once tries the handover to the target BS (Target BS, which will hereinafter be abbreviated to T-BS) defined as the handover destination but fails to make a registration procedure due to a slight deviation from the cell of the T-BS during the registration procedure, and returns to the handover source BS (Serving Bs, which will hereinafter be abbreviated to S-BS). Moreover, if the MS continues to stay in the vicinity of the border of the cell, such a possibility arises that the Ping-Pong effect might be repeated. If the Ping-Pong effect arises, the MS undergoes an increased period of time for which the data communications are interrupted due to making again the registration procedure to the S-BS, resulting in occurrence of wasteful consumption of a bandwidth due to the execution of the registration procedure.

A mechanism for coping with such a situation is that when taking the handover, the S-BS retains information necessary for the connection with the MS for a fixed period of time (Resource Retain Time, which will hereinafter be abbreviated to RRT), and the MS, if failing to do the registration process to the T-BS, can reestablish the connection without making again the registration procedure to the S-BS if within the RRT.

Herein, if a set value of the RRT is raised (elongated), there is an increased probability of switchback to the S-BS without making again the registration procedure, however, on the contrary a quantity of the resource consumption of the whole communication system rises. While on the other hand, if the set value of the RRT is decreased (shortened), though capable of reducing the quantity of the resource consumption of the whole communication system, there is a decreased probability of the switchback to the S-BS without making again the registration procedure. Namely, due to the occurrence of the Ping-Pong effect, data traffic (a quantity of the communications) needed for executing again the registration procedure increases.

FIG. 20 shows an operation sequence of the present procedure. What is considered as a situation is that the MS is located in the vicinity of the border between the neighboring base stations BS#1 and BS#2 and moves here and there between the two base stations BS.

An assumption is that the MS initially connects to the BS#1. The MS measures intensities of the radio waves of the BS#1, BS#2 and, when the intensity of the radio waves of the BS#1 is weakened while the intensity of the radio waves of the neighbor BS#2 rises, decides to take the handover to the BS#2. The MS, as a procedure for taking the handover to the BS#2, transmits a handover request (which will hereinafter be expressed as MOB_MSHO-REQ) message to the BS#1, and receives a handover response (which will hereinafter be expressed as MOB_MSHO-RSP) as a response thereto. The MS transmits a handover start (which will hereinafter be expressed as MOB_HO-IND (serving BS release) message just before switching over the reception radio waves to those transmitted from the BS#2. This message intends to notify the BS#1 that the MS moves away from the BS#1.

The MS, when receiving the MOB_HO-IND (serving BS release) message, switches over the reception radio waves to those transmitted from the BS#2. Further, the MS retains a variety of parameters defined as connection information needed for the MS to reconnect with the BS#1 by canceling the handover till an elapse of the RRT. Note that the BS#1 also, when receiving the MOB_HO-IND (serving BS release) message, retains the variety of parameters defined as the connection information needed for the MS to reconnect with the BS#1 by canceling the handover till the elapse of the RRT.

The MS decodes the radio waves transmitted from the BS#2, and starts receiving messages necessary for the connection to the BS#2, such as a DL-MAP (Downlink map) message and a DCD/UCD (Downlink Channel Descriptor/Uplink Channel Descriptor) message. It is herein presumed that the MS is disabled, though the MS temporarily receives the DL-MAP, the DCD/UCD, etc, from receiving the DL-MAP thereafter due to a movement of the MS itself. The MS, if unable to receive the DL-MAP message from the BS#2 till an elapse of time of a Lost DL-MAP timer, determines that the MS has moved off a cover area of the BS#2.

In this case, the MS, if before the elapse of the RRT, can reconnect to the previous Serving BS by canceling the handover to the BS#2. To be specific, the MS, when determining that the MS can not perform the communications with the BS#2, switches over the reception base station to the BS#1, and transmits a MOB_HO-IND (Cancel) message to the BS#1. The MS and the BS#1 retain the parameter information needed for the reconnection if before the elapse of the RRT, and can therefore resume the communications by use of this information. In this case, the MS can omit a reconnection procedure called Network Entry.

Thus, after starting the handover process, if before the elapse of the RRT, the reconnection to the handover source BS can be easily done by retaining the information for reverting to the pre-handover connection status. If the RRT is set to a long period of time, however, the quantity of consumption of a memory resource etc rises. Moreover, if the RRT is set to a short period of time and if the MS continues to move in the vicinity of the border of the cover area of the BS, the Network Entry process as shown in FIGS. 21A and 21B is repeatedly executed, resulting in an increased period of time for which the data communications are interrupted.

Such being the case, it is an object (of the present technology) to provide a communication control device and a communication control method for attaining increased efficiency of a handover process.

To solve the problems described above, setting of RRT is changed corresponding to a wireless connection status between a base station and a mobile terminal.

Specifically, a communication control device applied to a wireless communication system which establishes a wireless communication between a base station and a mobile terminal, comprises: a handover control unit controlling a handover process of the mobile terminal; and a setting unit setting a period of retain time of connection information used when the mobile terminal reconnects to a handover source base station by interrupting the handover process, wherein the handover control unit, after the mobile terminal has started the handover process, controls the handover process of the mobile terminal so as to retain the connection information till the retain time set by the setting unit elapses, and the setting unit changes setting of the retain time, corresponding to a communication status between the handover source base station and the mobile terminal.

A premise is that the communication control device is applied to a wireless communication system in which a plurality of base stations exists, and a mobile terminal maintains communications in a way that switches over a connection destination (connection target) base station. Namely, the premise is that each of the mobile terminals building up the wireless communication system has a handover function.

The handover control unit of the communication control device controls the handover process of the mobile terminal, especially the retain time (RRT (Resource Retain Time) of the connection information of the handover source, which is needed for canceling the handover. Herein, in the communication control device, the setting unit changes the setting of this retain time. The setting unit changes the setting of the retain time corresponding to a wireless connection status between the base station and the mobile terminal. The change in the wireless connection status between the base station and the mobile terminal implies, it is considered, that the mobile terminal moves and there is a high probability of taking the handover. The setting of the retain time is changed corresponding to the wireless connection status between the base station and the mobile terminal, thereby enabling the resources of the whole communication system to be effectively utilized. Namely, a quality of communication (Quality of Service: QoS) is enhanced by setting the sufficient retain time in the mobile terminal having the high probability of taking the handover, and the resources of the whole system can be reduced by setting the minimum retain time in the mobile terminal having a low probability of taking the handover.

Further, the mobile terminal tries the handover to a certain base station but fails to take the handover within the retain time and reconnects to the handover source base station, in which case the setting unit may set the retain time long in the case of taking the handover to a certain base station.

According to this configuration, if there is a record of past results of the failure in the handover, the retain time is set long, and hence the quality of communications for the mobile terminal to take the handover can be enhanced.

Moreover, the communication control device may further comprise a recording unit recording a connection event between the base station and the mobile terminal, wherein the setting unit may analyze the communication status on the basis of a content of the connection event recorded by the recording unit, and may change the setting of the retain time.

According to this configuration, the communication situation between the base station and the mobile terminal can be grasped simply by referring to a history of the connection events recorded in the recording unit.

Further, the recording unit may record the connection event containing an event of a start of the handover and an event of an interruption of the handover, and

the setting unit may calculate elapse time from the event of the start of the handover up to the event of the interruption of the handover that are recorded by the recording unit, and, if the calculated elapse time is longer than the retain time, may set the retain time long.

According to this configuration, the retain time is set based on processing time needed for the actual handover canceling process, and it is therefore possible to enhance the quality of communications when the mobile terminal moves in the vicinity of the border of the cover area of the base station.

Still further, the recording unit may record the connection event containing the event of the start of the handover and the event of the interruption of the handover, and

the setting unit may calculate the elapse time from the event of the start of the handover up to the event of the interruption of the handover that are recorded by the recording unit, and, if the calculated elapse time is shorter than the retain time, may set the retain time short.

According to this configuration, the retain time is set short based on the processing time needed for the actual handover canceling process, and it is therefore feasible to reduce the resources of the whole system.

Yet further, the recording unit may record the connection event containing the event of the interruption of the handover, and

the setting unit, if the event of the interruption of the handover is repeatedly recorded in the recording unit, may set the retain time long.

When the mobile terminal moves in the vicinity of the border of the cove area of the base station, the mobile terminal is easy to repeat a handover interruption event. Such being the case, the setting unit detects whether or not the mobile terminal moves in the vicinity of the border of the cover area by detecting whether or not the handover interruption event is repeatedly recorded, whereby the sufficient retain time can be set in the mobile terminal that repeats the cancellation of the handover.

Yet further, the setting unit may compare intensities of radio waves transmitted to the mobile terminal from the plurality of base stations with each other, and, if there exist at least two or more radio waves having substantially the same intensity, may set the retain time long.

When the mobile terminal moves in the vicinity of the border of the cover area of the base station, the radio waves of the base stations having substantially the same intensity of the radio waves reach the mobile terminal. Then, the setting unit detects whether the mobile terminal moves in the vicinity of the border of the cover area of the base station or not by comparatively analyzing the intensities of the radio waves, and can set the sufficient retain time in the mobile terminal having the high probability of canceling the handover.

Moreover, the mobile terminal, if the event of the interruption of the handover is repeated, may notify the setting unit of predetermined information, and the setting unit, when receiving the notification of the predetermined information from the mobile terminal, may set the retain time long.

According to this configuration, the setting unit can detect, based on only the information notified from the mobile terminal, whether or not the mobile terminal moves in the vicinity of the border of the cover area of the base station.

Furthermore, the setting unit may change the setting of the retain time, corresponding to a content of a registration procedure when the mobile terminal executes the handover process.

The time required for the handover process is determined based on a processing content. Hence, the content of the handover process is analyzed, and the setting of the retain time is changed based on the analyzed content, thereby enabling the proper retain time to be set even when the time actually expended for the handover process is unknown.

Further, the setting unit, if the mobile terminal interrupts the handover process and reconnects to the base station, may start the process of changing the setting of the retain time.

According to this configuration, the setting of the retain time of the mobile terminal having the high probability of canceling the handover can be changed, and the resources of the system requiring the setting change process can be reduced.

Additionally, the communication control device may be installed in the base station or in a host device of the base station.

The setting change process of the retain time is conducted in the base station or the host device thereof, and it is possible to attain the increased efficiency of the handover process of the whole communication system without increasing processing overhead between pieces of equipment related to the communication control device.

As described above, it is feasible to provide the communication control device and the communication control method that attain the increased efficiency of the handover process.

### BRIEF DESCRIPTION OF THE DRAWINGS

FIG. 1 is a view showing an example of a whole architecture of a communication system;

FIG. 2 is a diagram showing a positional relationship between a cell of a base station and a mobile communication terminal;

FIG. 3 is a diagram showing an outline of processes;

FIG. 4 is a diagram showing a configuration of a BS;

FIG. 5 is a diagram showing an RRT management table (initial state);

FIG. 6 is a diagram showing a configuration of a MS;

FIG. 7 is diagram showing an information flow between the base station and the mobile communication terminal in the case of a pattern 1;

FIG. 8A is diagram showing the information flow between the base station and the mobile communication terminal in the case of a pattern 2;

FIG. 8B is a diagram showing the information flow between the base station and the mobile communication terminal in the case of the pattern 2;

FIG. 9 is a diagram showing an example of an operation flow of an RRT management unit;

FIG. 10 is a diagram showing a HO history table;

FIG. 11 is a diagram showing the RRT management table (after being updated);

FIG. 12 is a diagram showing an information flow between the base station and the mobile communication terminal after dynamically changing the RRT;

FIG. 13 is a diagram showing an operation flow of the RRT management unit;

FIG. 14 is a diagram showing a HO time estimation table;

FIG. 15 is a diagram showing a HO time estimation table;

FIG. 16 is a diagram showing an example of the operation flow of the RRT management unit;

FIG. 17 is a diagram showing an example of the operation flow of the RRT management unit;

FIG. 18 is a diagram showing an example of the operation flow of the RRT management unit;

FIG. 19 is an explanatory diagram showing a background;

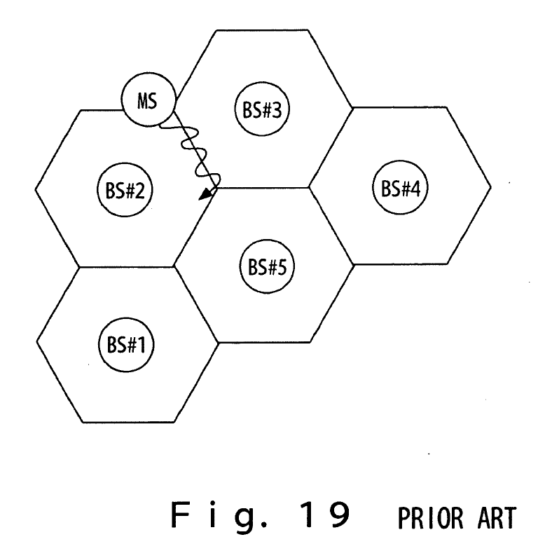

FIG. 20 is a diagram showing a processing flow of the prior art;

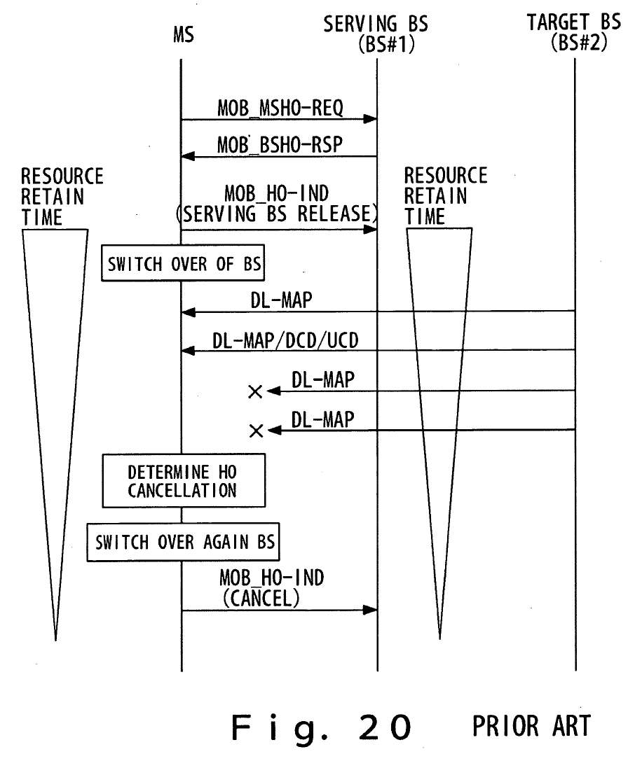

FIG. 21A is a diagram showing a processing flow of the prior art; and

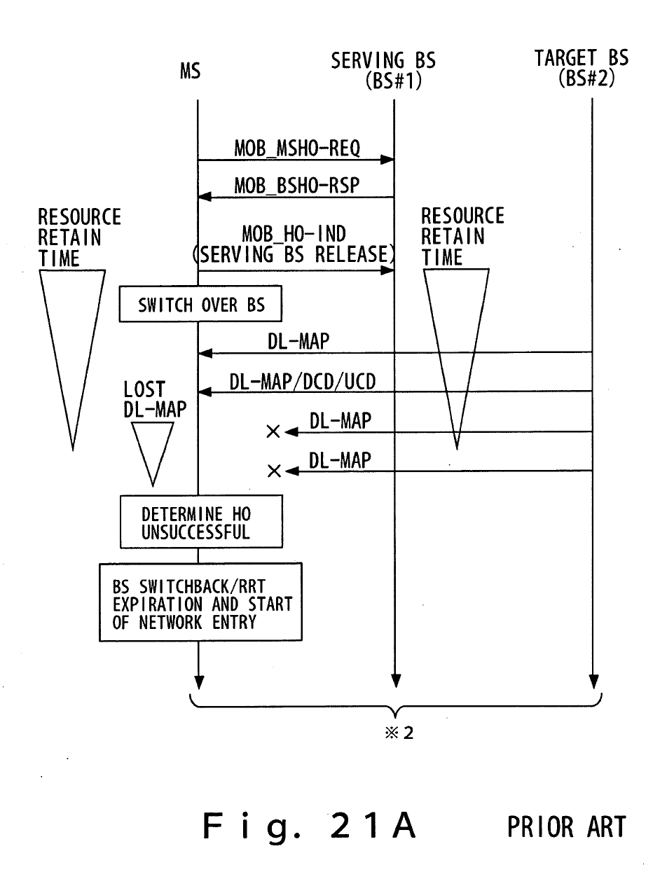

FIG. 21B is a diagram showing a processing flow of the prior art.

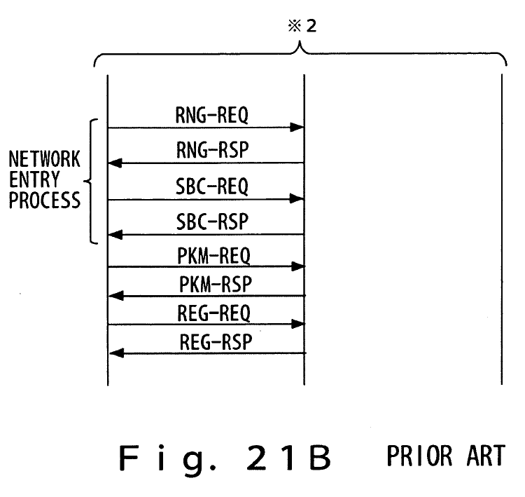

### DETAILED DESCRIPTION

One embodiment will be described by way of an exemplification with reference to the drawings.

<Configuration of Embodiment>

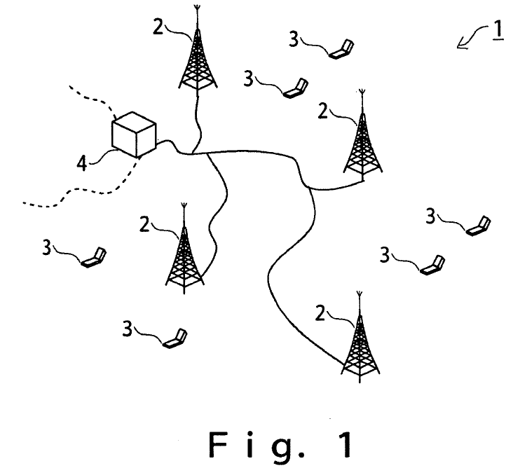

FIG. 1 is a view showing an example of a whole architecture of a communication system 1 according to one embodiment. As illustrated in FIG. 1, the communication system 1 includes base stations BS (Base Station) 2 as a plurality of wireless base stations that are terrestrially installed based on a cell system, mobile stations MS (Mobile Station) 3 as mobile communication terminals that move within a cell covered by the BS 2 and wirelessly connect to the BS 2, and an ASN-GW (Access Service Network-Gateway) 4 which establishes connections among the base stations BS 2. The wireless communication system according to the present embodiment is a communication system pursuant to WiMAX (Worldwide Interoperability for Microwave Access), and the BS 2 and the MS 3 perform the communications based on the specification of IEEE802.16e. Note that the MS 3 is constructed of, e.g., a mobile phone, a PDA (Personal Digital Assistant), etc.

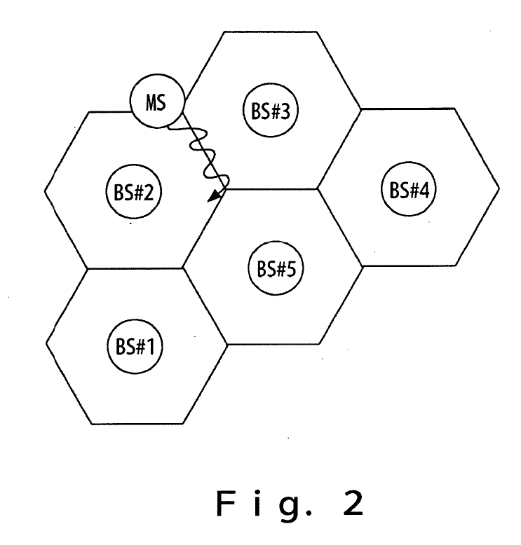

FIG. 2 shows one example of a positional relationship between a cell of each of the base stations BS 2 (BS#1-BS#5) and the MS 3. A hexagon depicted in FIG. 2 represents a range (cell) in which each BS 2 can cover the communications. Each BS 2 has a unique BS identifier by which the MS 3 can identify the BS 2. The BS 2 is disposed without any gaps between the cells except unpopulated areas and geographically-installation-disabled locations. The embodiment, for example, as shown in FIG. 2, the MS 3 moving in the vicinity of a border between the cells of the BS 2 (in the vicinity of the border between the cell of the BS#2 and the cell of the BS#3), deals with a scheme that the MS 3 moving in the vicinity of the border between the cells undergoes repetitive handovers between the different BS 2 (which are, i.e., the BS#2 and BS#3). The handover consumes resources of the BS 2 and the MS 3 because of executing establishing reconnections (Network Re-entry).

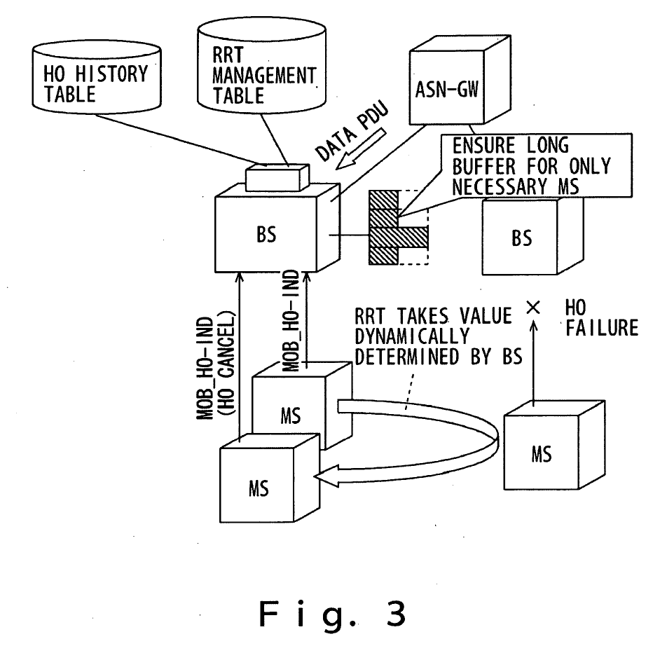

FIG. 3 shows an outline of processes by the communication system 1 according to the embodiment. As illustrated in FIG. 3, the communication system 1 according to the embodiment dynamically changes an RRT (Resource Retain Time, which corresponds to retain time according to the present technology) corresponding to a status of the MS 3, thereby attaining higher efficiency of a buffer of the BS 2 even when the connections are repeated and thus reducing the system resources (especially the memory etc).

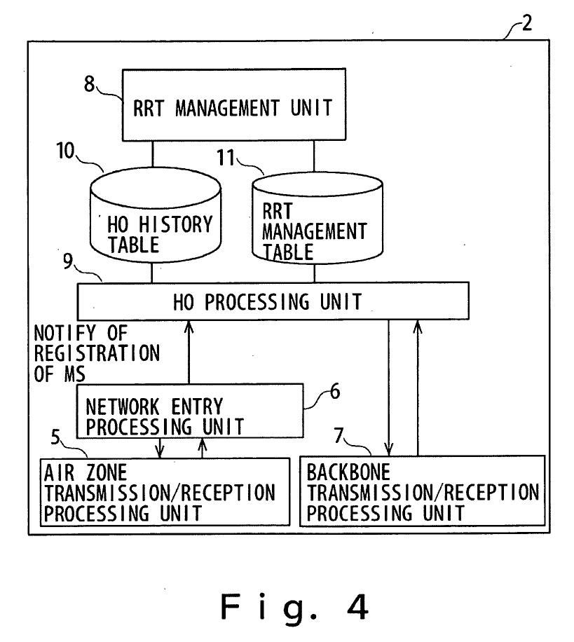

FIG. 4 shows an example of a configuration of the BS 2. As shown in FIG. 4, the BS 2 includes an air zone transmission/reception processing unit 5, a network entry processing unit 6, a backbone transmission/reception processing unit 7, an RRT management unit 8 (corresponding to a setting unit according to the present technology), and a HO (Hand-Over) processing unit 9 (corresponding to a control unit according to the present technology). Further, the BS 2 has a HO history table 10 (which corresponds to a recording unit according to the present technology) retained in a storage device and an RRT management table 11.

The air zone transmission/reception processing unit 5 performs the communications between the BS 2 and the MS 3. To be specific, the air zone transmission/reception processing unit 5 converts a variety of messages generated by the respective processing units into radio waves and transmits the radio waves; and the air zone transmission/reception processing unit 5, in turn, receives the radio waves transmitted from the MS 3, extracts the messages therefrom and transfers the messages to the respective processing units. The air zone transmission/reception processing unit 5 includes a transmission/reception amplifier, a filter, a frequency converter, A/D-D/A converter and a quadrature MODEM, wherein RF (Radio Frequency) signals transmitted from the MS 3 are converted into digital baseband signals, and the digital baseband signals to be transmitted are converted into the RF signals. Further, the air zone transmission/reception processing unit 5 conducts the communications based on a time division multiplexing method and can measure incoming electric power etc of the MS 3.

The network entry processing unit 6 processes a registration procedure protocol for establishing the connection between the MS 3 and the BS 2. Specifically, the network entry processing unit 6 transfers a control message for an exchange with the MS 3 to the air zone transmission/reception processing unit 5, and receives, from the air zone transmission/reception processing unit 5, the control message of which the MS 3 notifies. Moreover, the network entry processing unit 6, after completing the registration procedure and connecting to the MS 3, periodically exchanges the control message with the MS 3 via the air zone transmission/reception processing unit 5, thus checking the connection status with the MS 3.

The HO processing unit 9, if requested by the MS 3 to take the handover, exchanges a context of the MS 3 with the BS 2 serving as a handover destination, and requests the ASN-GW 4 to temporarily buffer a traffic (data). Further, the HO processing unit 9 also executes a process for handing over the base station for the MS 3, corresponding to the communication status, etc with the MS 3. Further, the HO processing unit 9, when a new MS 3 in a non-connected status requests the handover and when the network entry processing unit 6 notifies that this MS 3 is newly registered, requests the handover-source BS 2 for the context, and reestablishes the connection of a communication path with the ASN-GW 4. The HO processing unit 9 determines, from a data error rate calculated based on the incoming electric power in the communications between the BS 2 and the MS 3, an SINR (Signal-to-Interference and Noise power Ratio) and CRC (Cyclic Redundancy Check) information, whether the handover process is required or not.

The backbone transmission/reception processing unit 7 executes a process of transmitting and receiving the messages to and from other base stations BS 2 via a backbone network (i.e., a network such as the ASN-GW 4 that connects the BS 2 to each other).

The RRT management unit 8 dynamically determines an RRT in accordance with a handover history of each of the mobile stations MS 3, which is recorded in the HO history table 10, and records the thus-determined RRT in the RRT management table 11.

The HO history table 10 is recorded with the HO history of which the HO processing unit 9 notifies. Namely, the HO history table 10 is recorded with a history that the MS 3 kept in the wireless connection with the BS 2 performs the handover to another BS 2. The handover history of the MS 3 includes, e.g., a history showing that the MS 3 starts the handover based on a handover instruction sent from the BS 2 or reconnects to another BS 2 due to an interruption of the communications between the BS 2 and the MS 3.

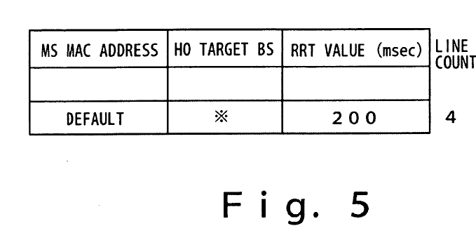

The RRT management table 11 is recorded with the RRT of which the RRT management unit 8 notifies. FIG. 5 shows a content of the RRT management table 11 in an initial state. As shown in the table of FIG. 5, the RRT of 200 msec is set as a default value in the RRT management table 11 in the initial state. The RRT management table 11 is recorded with the RRT dynamically determined by the RRT management unit 8 on the basis of the history recorded in the HO history table 10. The RRT recorded in the RRT management table 11 is information to which the HO processing unit 9 refers. The RRT recorded in the RRT management table 11 is the information to which the HO processing unit 9 refers in order to determine a period of time for retaining the context defined as information on the connection status with the MS 3 when the handover process for the MS 3 occurs in the HO processing unit 9. What has been described so far is the configuration of the BS 2.

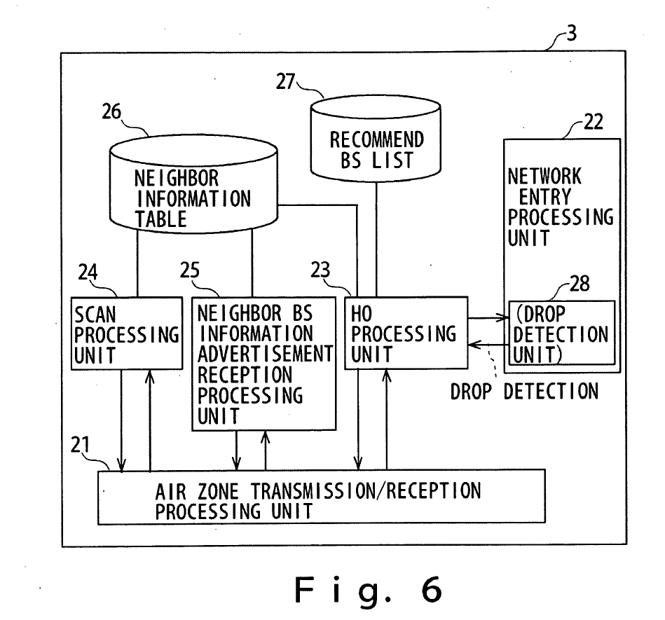

Next, a configuration of the MS 3 will be explained. FIG. 6 illustrate the configuration of the MS 3. As illustrated in FIG. 6, the MS 3 includes an air zone transmission/reception processing unit 21, a network entry processing unit 22, a HO processing unit 23, a scan processing unit 24, a neighbor BS information advertisement reception processing unit 25, a neighbor information table 26, a recommend BS list 27 and a drop detection unit 28.

The air zone transmission/reception processing unit 21, in the same way as the processing unit of the BS 2 does, performs the wireless communications between the BS 2 and the MS 3. To be specific, the air zone transmission/reception processing unit 21 converts the variety of messages generated by the respective processing units into the radio waves and transmits the radio waves; and the air zone transmission/reception processing unit 21, in turn, receives the radio waves transmitted from the BS 2, extracts the messages therefrom and transfers the messages to the respective processing units.

The network entry processing unit 22, in the same way as the processing unit of the BS 2 does, processes the registration procedure protocol for establishing the connection between the MS 3 and the BS 2. Specifically, the network entry processing unit 22 transfers the control message for the exchange with the BS 2 to the air zone transmission/reception processing unit 21, and receives, from the air zone transmission/reception processing unit 21, the control message of which the BS 2 notifies. Moreover, the network entry processing unit 22, after completing the registration procedure and connecting to the BS 2, periodically exchanges the control message with the BS 2 via the air zone transmission/reception processing unit 21, thus checking the connection status with the BS 2.

The HO processing unit 23 exchanges the context of the MS 3 with the BS 2, and switches over synchronization of the wireless communications with the air zone transmission/reception processing unit 21. Further, the HO processing unit 23 executes the handover process corresponding to the communication status etc with the BS 2. Note that the HO processing unit 23 has a function of, if trying to carry out the handover to the new BS 2 but interrupting this process without completing a network entry process, canceling the handover and reestablishing the connection with the handover source BS 2.

The scan processing unit 24 measures an intensity of the radio waves of the BS 2 keeping the wireless connection and an intensity of the radio waves of the neighbor BS 2 defined as a candidate for the handover destination. The scan processing unit 24 has a function of, in order to measure the intensity of the radio waves, exchanging a message for negotiation about a period of scan time of the wireless communications with the BS 2 keeping the wireless connection, and instructing the air zone transmission/reception processing unit 21 to switch over the BS 2 keeping the wireless connection.

The neighbor BS information advertisement reception processing unit 25 receives a message about items of information on the neighbor BS 2, which are periodically transmitted (advertised to the network) by the BS 2 keeping the wireless connection, and registers these received items of information in the neighbor information table 26.

The neighbor information table 26 is a recording medium such as a memory and is a table for registering the information on the neighbor BS 2, which is periodically transmitted (advertised to the network) by the BS 2 keeping the wireless connection.

The recommend BS list 27 is a list recorded on the recording medium such as the memory, and is a list of the handover candidate BS 2 recommended by the BS 2 keeping the wireless connection when the MS 3 sends a handover request message to the BS 2 keeping the wireless connection. The MS 3 normally selects the handover destination BS 2 from this list.

The drop detection unit 28 is one component of the network entry processing unit 22 and periodically exchanges the message for checking whether the connecting status with the BS 2 keeping the wireless connection is maintained or not. The drop detection unit 28, if unable to acquire this message from the BS 2, determines that the connection with the BS 2 keeping the wireless connection is cut off.

<Processing Flow in Embodiment>

Next, an example of a processing flow of the BS 2 will be explained. Incidentally, before explaining the example of the processing flow of the BS 2, a flow of the information exchanged between the MS 3 and the BS 2 on the occasion of the handover will be described. The handover source BS 2 will hereinafter be termed S-BS 2 (Serving-BS), while the handover destination BS 2 is termed T-BS 2 (Target-BS). The S-BS 2 and the T-BS 2 have the same configuration.

Connection events occurring between the MS 3 and the BS 2 are classified into a reconnection event due to the cancellation of the handover and other events. A pattern (which will hereinafter be called a pattern 1) of occurrence of the reconnection event is that the MS 3 keeping the connection with the S-BS 2 gets into a failure in the handover to another BS 2 (i.e., the T-BS 2) but can cancel the handover because it is before a elapse of the RRT. Other patterns are a pattern (which will hereinafter be referred to as a pattern 2) of the occurrence of the event other than the reconnection event is that the MS 3 keeping the connection with the S-BS 2 gets into a failure in the handover to another BS 2 with the elapse of the RRT, a pattern (which will hereinafter be called a pattern 3) that the MS 3 residing within the cell of the S-BS 2 requests a new connection, and a pattern (which will hereinafter be called a pattern 4) that the MS 3 keeping the connection with another BS 2 moves into the cell of the new BS 2 and requests the handover. In-depth descriptions of the pattern 1 and the pattern 2 defined as the patterns related to the RRT will be made.

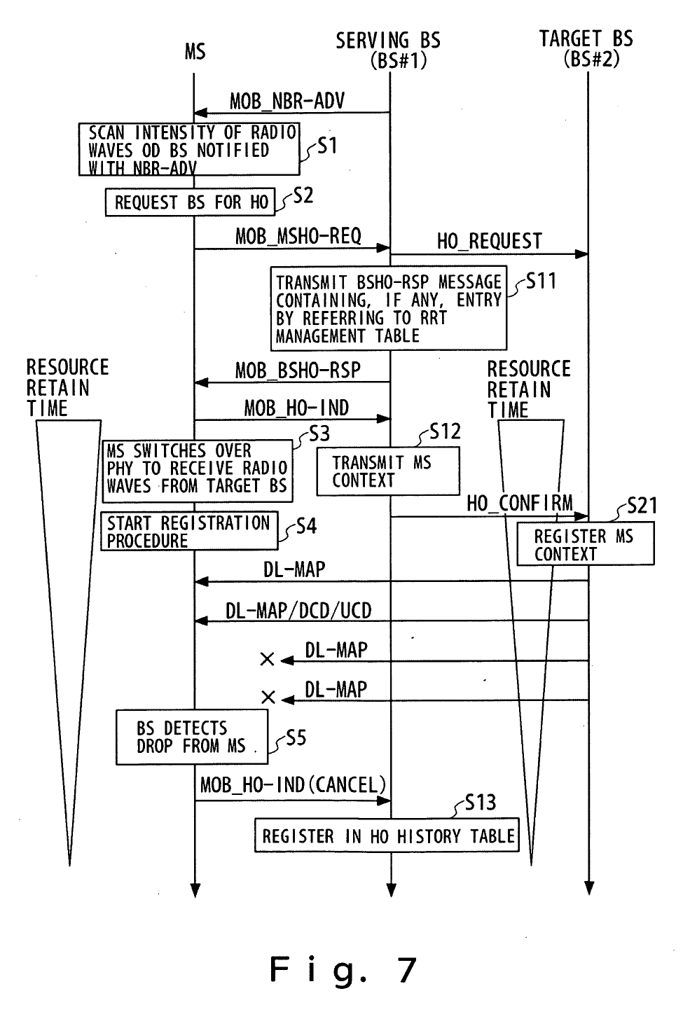

FIG. 7(the pattern 1) shows an example of an information flow between the MS 3 and the BS 2 in the case of the pattern 1 (the cancellation of the handover). The example of the flow in the case where the MS 3 cancels the handover and reestablishes the connection with the S-BS 2 within a period of RRT, will hereinafter be described in detail with reference to FIG. 7. The pattern 1 shows a processing flow that the MS 3 moves here and there in the vicinity of the border of the cell of the BS 2 and tries the handover to the T-BS 2 from the S-BS 2 keeping the wireless connection but gets into the failure in the handover, and the connection target is returned to the S-BS 2.

As shown in FIG. 7, the MS 3 receives MOB_NBR-ADV (Neighbor Advertisement Message) defined as information of the neighbor base station, which is broadcasted from the S-BS 2, and periodically measures, based on this message, the intensity of the radio waves of the T-BS 2 (S1).

The MS 3, if the intensity of the radio waves of the T-BS 2 becomes stronger than the intensity of the radio waves of the S-BS 2 due to the movement of the MS 3 itself, notifies the S-BS 2 of MOB_MSHO-REQ (MS HO request message) defined as information purporting a handover request (S2). This message MOB_MSHO-REQ contains an identifier of the T-BS 2 given as the candidate for the handover destination (Target BS).

The S-BS 2, when receiving the notification of MOB MSHO-REQ from the MS 3, notifies the T-BS 2 of the handover request and also notifies the MS 3 of MOB_BSHO-RSP (BS HO response message) as information purporting a handover instruction (S11). Note that the S-BS 2 refers to the RRT management table 11 before notifying of the MOB BSHO-RSP, and, if the RRT of the MS 3 notifying of MOB_MSHO-REQ is set (recorded) in the table 11, notifies the MS 3 of MOB_BSHO-RSP containing the information on this RRT value. Incidentally, the S-BS 2, if the RRT of the MS 3 notifying of MOB_MSHO-REQ is not set (not recorded) in the RRT management table 11, notifies the MS 3 of MOB BSHO-RSP containing information on a default RRT value (e.g., 200 msec).

The MS 3, when receiving the notification of MOB_BSHO-RSP from the S-BS 2, notifies the S-BS 2 of MOB_HO-IND (HO indication message) defined as information purporting a start of the handover process, and switches over PHY (physical layer) of the air zone transmission/reception processing unit 5 in order to receive the radio waves from the T-BS 2 (S3). Note that the MS 3 starts up a timer simultaneously with notifying of MOB_HO-IND. The MS 3, till the time of this timer elapses over the RRT value contained in MOB_BSHO-RSP, retains the information (the context) needed for the connection with the S-BS 2.

The S-BS 2 notified of MOB_HO-IND transmits the context as the information needed for the connection of the MS 3 to the T-BS 2 (S12). Note that the S-BS 2, in the same way as the MS 3 does, starts up the timer when receiving the notification of MOB_HO-IND from the MS 3. Then, the S-BS 2 retains the information of the connection with the MS 3 till the time of the timer elapses over the time indicated by the RRT value notified to the MS 3.

Further, the T-BS 2 receiving the context of the MS 3 from the S-BS 2 registers the context of the MS 3 (S21).

The MS 3, after switching over PHY, starts the registration procedure of the T-BS 2 (S4). To be specific, the MS 3 receives DL_MAP (Downlink map) and DCD/UCD (Downlink Channel Descriptor/Uplink Channel Descriptor) that contain the identifying information etc of the T-BS 2, which are transmitted from the T-BS 2. Then, the MS 3 establishes the synchronization of a MAC (Media Access Control) layer on the basis of this information, and performs, with respect to the T-BS 2, a network connection procedure (Network Entry) defined as the connection event to the T-BS 2. The network connection procedure connotes a basic connection procedure pursuant to WiMAX, which is conducted when the MS 3 connects to the BS 2 and starts the communications, and embraces four sequences such as a Ranging sequence (RNG-REQ, RNG-RSP message exchange) for the MS 3 to adjust the electric power, timing and a frequency with respect to the BS 2, a Basic Capability sequence (SBC-REQ, SBC-RESP message exchange) for negotiating the BS 2 with respect to the function and the performance held by the MS 3, a PKM sequence (PKM-REQ, PKM-RSP message exchange) for authentication and exchanging an encryption key when the MS 3 connects to the network, and a Registration sequence (REG-REQ, REG-RSP message exchange) for a request for the registration of the MS 3 in the network.

Herein, when the MS 3 moves away from the T-BS 2 till the network connection procedure is completed, the DL-MAP and the DCD/UCD transmitted from the T-BS 2 do not reach the MS 3. It is improper for the MS 3 to take the handover to the T-BS 2 in such a situation. Such being the case, the MS 3, if the data such as the DL-MAP transmitted from the T-BS 2 is interrupted with the result of getting desynchronized with the T-BS 2, checks the elapse time of the timer since the notification of MOB_HO-IND has been given. The MS 3, if before the elapse time of the timer elapses over the RRT (which is on the order of 200 msec in the case of the default value), notifies the S-BS 2 of MOB_HO-IND (Cancel) defined as the information purporting the cancellation of the handover on the basis of the retained connection information of the S-BS (S5).

The S-BS 2 receiving the notification of MOB_HO-IND (Cancel) from the MS 3 records the event of canceling the handover in the HO history table 10 and resumes the communications with the MS 3 (S13).

What has been discussed so far is the description of the example of the processing flow in which the MS 3 cancels the handover and reconnects to the S-BS 2 within the period of RRT.

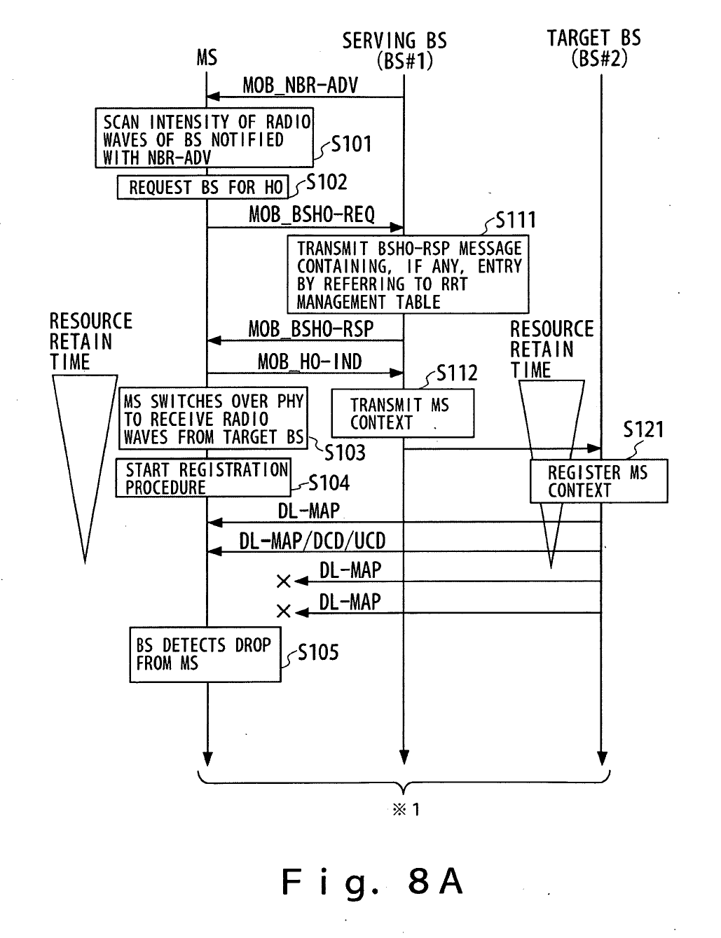

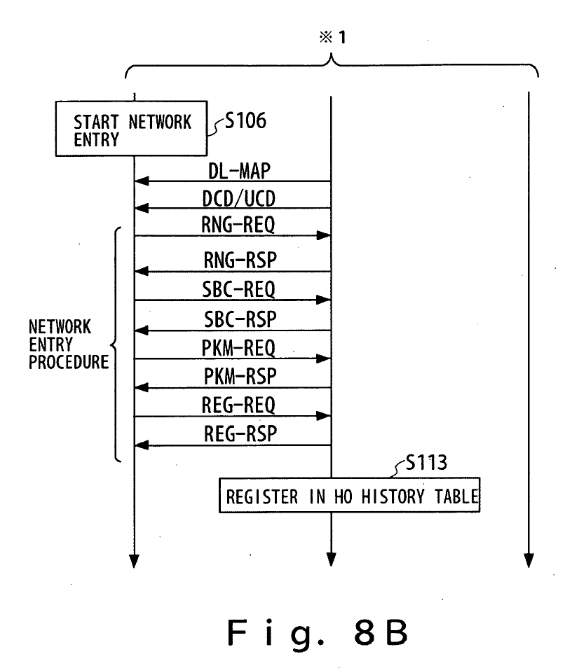

FIGS. 8A and 8B (the pattern 2) show an example of the information flow between the MS 3 and the BS 2 in the case of the pattern 2. The example of the information flow, in which the MS 3 cancels the handover, though the RRT elapses, and reconnects to the S-BS 2, will be described in detail with reference to FIGS. 8A and 8B. Note that the processes up to step S104 are the same as those up to step S4 in the pattern 1 described above.

The MS 3 switching over PHY receives the DL-MAP and the DCD/UCD transmitted from the T-BS 2 and makes, based on these items of information, the registration procedure of the T-BS 2. Herein, the MS 3, if disabled from receiving the data such as the DL-MAP transmitted from the T-BS 2 though the notification of MOB_HO-IND has been given (S105) and if the RRT elapses, switches over PHY again to the S-BS 2, and starts the registration procedure with respect to the S-BS 2. Namely, the MS 3 receives the DL-MAP and the DCD/UCD sent from the S-BS 2 and makes Network Entry defined as the connection event to the S-BS 2 (S106). The S-BS 2, when completing the network connection procedure with the MS 3, registers this event in the HO history table 10 (S113). Upon the completion of the network connection procedure, the MS 3 reconnects (a return connection) to the S-BS 2.

What has been discussed so far is the information flow between the MS 3 and the BS 2 when the MS 3 takes the handover.

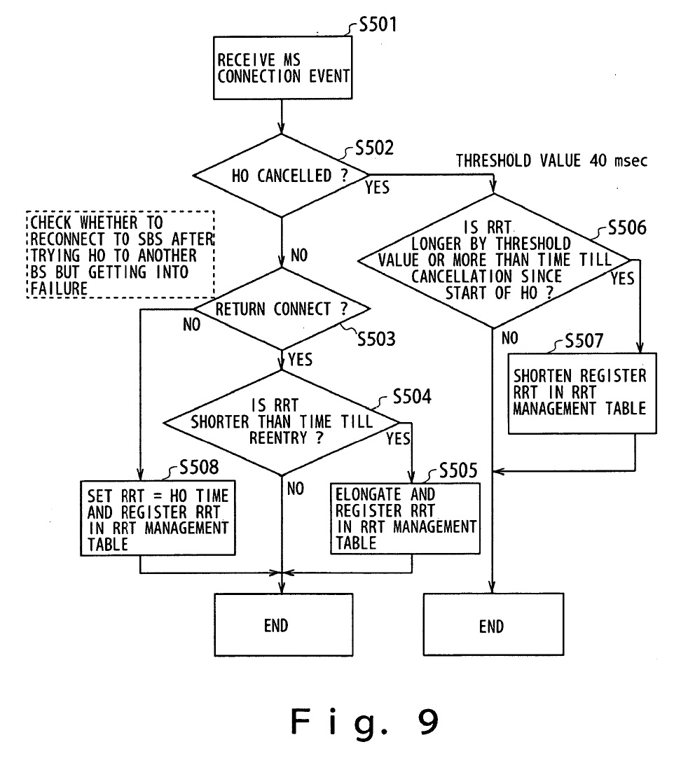

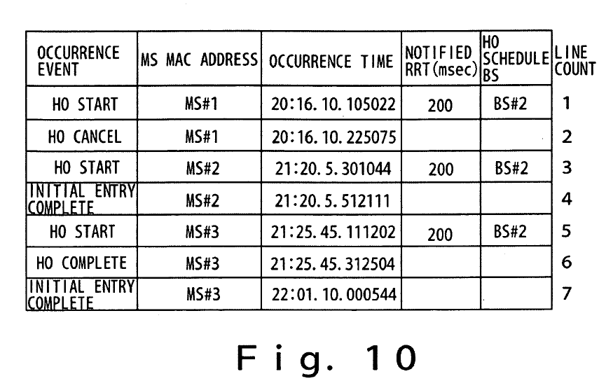

A processing flow of the BS 2 will hereinafter be exemplified. FIG. 9 shows the example of the processing flow of the BS 2. Further, FIG. 10 shows a content of the HO history table 10 of the S-BS 2. The description will hereinafter be made with reference to the flowchart in FIG. 9 and the HO history table in FIG. 10.

When the network entry processing unit 22 accepts the connection event transmitted from the MS 3 (step S501) and when the HO processing unit 9 writes this connection event to the HO history table 10, the RRT management unit 8 acquires a content of the connection event written to the HO history table 10.

The RRT management unit 8 checks whether or not the connection event written to the HO history table 10 is the cancellation of the handover (step S502). If the connection event accepted by the network entry processing unit 22 from the MS 3 is MOB_HO-IND (Cancel) (i.e., the pattern 1), the event of the cancellation of the handover is recorded in the HO history table 10. The RRT management unit 8 executes the processes from S506 onward if the connection event recorded in the HO history table 10 is the cancellation of the handover (the pattern 1) as specified in the second line of the table in FIG. 10 (which is the case where the MAC address is MS#1 as shown in the table in FIG. 10). By Contrast, the S-BS 2, if the connection event recorded in the HO history table 10 is “INITIAL ENTRY Complete” (which is any one of the patterns 2-4) as specified in the fourth and seventh lines in the table in FIG. 10, executes the processes from S503 onward (which is the case where the MAC address is MS#2 or MS#3 as shown in the table in FIG. 10).

The RRT management unit 8, if the connection event recorded in the HO history table 10 is not the cancellation of the handover but “INITIAL ENTRY Complete”, checks whether or not this connection event is the return connection (i.e., the pattern 2) (step S503). Namely, the RRT management unit 8 refers to the HO history table 10 and thus searches for an event anterior to “INITIAL ENTRY Complete”. The RRT management unit 8, for instance, as in the case of MS#2 in the table in FIG. 10, if the event anterior to the “INITIAL ENTRY Complete” event (which is specified in the fourth line in the table in FIG. 10) is an “HO Start” event (the third line in the table in FIG. 10) and if there is no record of an event (HO Complete) purporting the completion of the handover between the “INITIAL ENTRY Complete” event and the “HO Start” event, determines that the “INITIAL ENTRY Complete” event is derived from the return connection (which is, i.e., the case of the pattern 2), and executes the processes from S504 onward. On the other hand, the RRT management unit 8, for example, as in the case of MS#3 in the table in FIG. 10, if there is a record of the “HO complete” event (the sixth line in the table in FIG. 10) before the “INITIAL ENTRY Complete” event (the seventh line in the table in FIG. 10), determines that the connection event notified from the MS 3 is not derived from the return connection (i.e., the pattern 3 or 4), and executes the processes from S508 onward.

The RRT management unit 8, if the connection event notified from the MS 3 is the return connection (the pattern 2), checks whether or not a time length of the RRT is shorter than a period of time till a reentry is made (step S504). To be specific, the RRT management unit 8 refers to the HO history table 10 and thus searches for an event (i.e., the event specified in the third line in the table in FIG. 10) when starting the handover tracing back from the “INITIAL ENTRY Complete” event (which is specified in the fourth line in the table in FIG. 10). Then, the RRT management unit 8 calculates a time difference γ between the “Handover Start” event and the “INITIAL ENTRY Complete” event. Herein, the RRT management unit 8, if the time difference γ is larger than the RRT notified to the MS 3 with MOB BSHO-RSP, executes the processes from S505 onward. The RRT management unit 8, whereas if the time difference γ is smaller than the RRT notified to the MS 3 with MOB_BSHO-RSP, determines that the RRT is the proper value, and finishes the RRT change process. In the case of the example given in the table in FIG. 10, the time difference γ (=211 msec) is larger than the RRT (=200 msec) notified to the MS 3, and hence the RRT management unit 8 executes the process in S505.

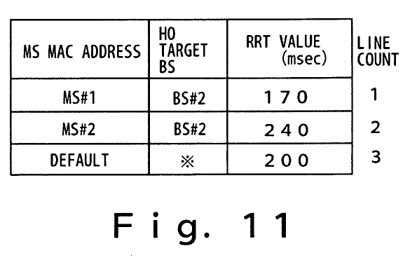

The RRT management unit 8 corrects the RRT of the MS 3 that is recorded in the RRT management table 11 (step S505). Let RRTi be the RRT before being corrected and RRTn be the RRT after being corrected. The RRT management unit 8, when determining in step S504 that RRTi <γ, sets, as the RRTn, a value obtained in a way that multiplies the RRTi by 1.2 (i.e., RRTn RRTi*1.2). Then, the RRT management unit 8 writes the thus-calculated RRTn as a new RRT of the MS 3 to the RRT management table 11. In the case of the example in the table in FIG. 6, a value (=240 msec) obtained by RRTi (=200 msec) by 1.2 becomes the RRTn. FIG. 11 shows a content of the RRT management table 11 after the RRT is updated. As shown in FIG. 11, 240 msec is recorded as the RRT value of the MS 3 (MS#2) in the RRT management table 11.

On the other hand, the RRT management unit 8, if the connection event recorded in the HO history table 10 is the cancellation of the handover (i.e., the pattern 1), checks whether or not the length of the RRT is longer by a threshold value or over than a period of time till the handover is canceled since the handover process has been started (step S506). Namely, the RRT management unit 8 refers to the HO history table 10 and thus searches for the event (i.e., the event specified in the first line in the table in FIG. 10) when the canceled handover resumes tracing back from the “Handover Cancel” event (the second line in the table in FIG. 10). Then, the RRT management unit 8 calculates a time difference δ between the “Handover Start” event and the “Handover Cancel” event. Herein, the RRT management unit 8, if the RRT of which the HO processing unit 9 notifies the MS 3 is larger than a value obtained in a way that adds a threshold value tth (which is previously set to 40 msec in this case) to the time difference δ, executes the processes from S507 onward. The RRT management unit 8, whereas if the RRT of which the HO processing unit 9 notifies the MS 3 is equal to or smaller than the value obtained in a way that adds the threshold value tth to the time difference δ, determines that the RRT is the proper value, and finishes the RRT change process. In the case of the example in the table in FIG. 10, the value obtained by adding the threshold value tth (=40 msec) to the time difference δ (=120 msec) is smaller than the RRT (=200 msec) notified to the MS 3, and hence the S-BS 2 executes the process in step S507.

The RRT management unit 8, if the RRT is not proper, corrects the RRT of the MS 3 that is recorded in the RRT management table 11 (step S507). The RRT management unit 8, when determining in step S506 that RRT>δ+tth, sets a value obtained by multiplying RRTi by 0.85 as RRTn (i.e., RRTn=RRTi*0.85). Then, the RRT management unit 8 writes the calculated RRTn as a new RRT of the MS 3 to the RRT management table 11. In the case of the example of the table in FIG. 6, the value (=170 msec) obtained by multiplying the RRTi (=200 msec) by 0.85 becomes the RRTn. As illustrated in FIG. 11, 170 msec is recorded as the RRT value of the MS 3 (MS#1) in the RRT management table 11. The RRT change process is thereby completed. Next, when the connection event of the MS 3 occurs, the HO processing unit 9 executes the HO process based on the new RRT recorded in the RRT management table 11.

While on the other hand, the RRT management unit 8, when determining that the connection event of the MS 3 is not derived from the return connection, changes the time needed for the handover of the MS 3 to the RRT (step S508). Namely, the RRT management unit 8 refers to the HO history table 10, and thus calculates a period of time till the handover is completed since the handover for MS 3 (MS#3) has been started (which is the elapse time, approximately 201 msec, from the event specified in the fifth line to the event in the sixth line in the case in FIG. 10). The RRT management unit 8 sets the thus-calculated elapse time as the RRTn, and writes this RRTn as a new RRT value of the MS 3 (MS#3) to the RRT management table 11. The RRT change process is thereby completed. Note that if the history of the handover is not recorded in the HO history table 10, a series of processes are finished without changing the RRT.

The description of the example of the processing flow executed by the BS 2 is given as below. The following discussion will deal with an information flow between the MS 3 and the BS 2 when executing the handover after updating the RRT recorded in the RRT management table 11.

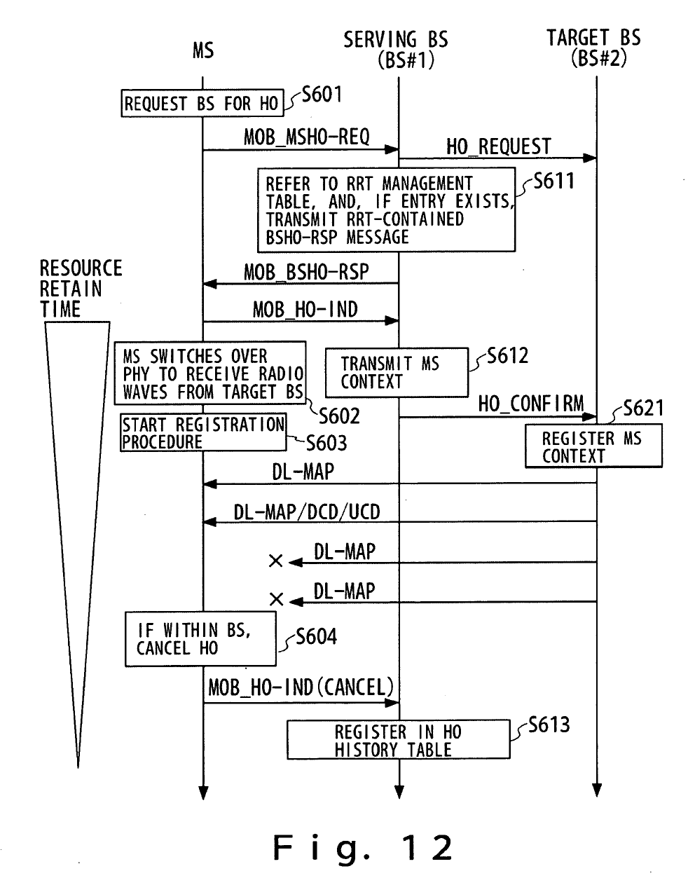

FIG. 12 shows the information flow between the MS 3 and the BS 2 when executing the handover after updating the RRT recorded in the RRT management table 11. An in-depth description of an example of the flow when the MS 3 cancels the handover but reconnects to the S-BS 2 within the period of RRT, will be made with reference to FIG. 12. The following flow exemplifies a flow where, in the same way as in the pattern 1, the MS 3 moves here and there in the vicinity of the border of the cell of the BS 2 and tries the handover to the T-BS 2 from the S-BS 2 keeping the wireless connection but gets into the failure in the handover, and the connection target is returned to the S-BS 2.

The MS 3, if the intensity of the radio waves of the T-BS 2 becomes stronger than the intensity of the radio waves of the S-BS 2 due to the movement of the MS 3 itself, notifies the S-BS 2 of MOB_MSHO-REQ (MS HO request message) defined as information purporting a handover request (S601). This message MOB_MSHO-REQ contains an identifier of the T-BS 2 given as the candidate for the handover destination.

The S-BS 2, when receiving the notification of MOB MSHO-REQ from the MS 3, notifies the MS 3 of MOB_BSHO-RSP as information purporting the handover instruction (S611). Note that the S-BS 2 refers to the RRT management table 11 before notifying of the MOB BSHO-RSP, and, if the RRT of the MS 3 notifying of MOB_MSHO-REQ is set (recorded) in the table 11, notifies the MS 3 of MOB_BSHO-RSP containing the information on this RRT value. Herein, for example, when the MS 3 is the MS#1, the RRT of 170 msec is set in the RRT management table 11, and hence the S-BS 2 notifies the MS 3 of MOB_BSHO-RSP containing the information on this RRT value (170 msec).

The MS 3, when receiving the notification of MOB_BSHO-RSP from the S-BS 2, notifies the S-BS 2 of MOB_HO-IND defined as information purporting the execution of the handover, and switches over PHY of the air zone transmission/reception processing unit 5 in order to receive the radio waves from the T-BS 2 (S602). Note that the MS 3 starts up he timer simultaneously with notifying of MOB_HO-IND. The MS 3, till the time of this timer elapses over the RRT (170 msec) contained in MOB_BSHO-RSP, retains the connection information with respect to the S-BS 2.

The S-BS 2 notified of MOB_HO-IND transmits the context as the information needed for the connection of the MS 3 to the T-BS 2 (S12) via the backbone transmission/reception processing unit 7 (S612). Note that the S-BS 2, in the same way as the MS 3 does, starts up the timer when receiving the notification of MOB_HO-IND from the MS 3. Then, the S-BS 2 retains the information of the connection with the MS 3 till the time of the timer elapses over the time indicated by the RRT value notified to the MS 3.

Further, the T-BS 2 receiving the context of the MS 3 from the S-BS 2 registers the context of the MS 3 (S621).

The MS 3, after switching over PHY, starts the registration procedure of the T-BS 2 (S603). To be specific, the MS 3 receives the DL MAP and the DCD/UCD that contain the identifying information of the T-BS 2, which are transmitted from the T-BS 2. Then, the MS 3 establishes the synchronization of a MAC (Media Access Control) layer on the basis of this information, and exchanges, with the T-BS 2, the network connection procedure (Network Entry) defined as the connection event to the T-BS 2.

Herein, when the MS 3 moves away from the T-BS 2, the data such as the DL-MAP and the DCD/UCD transmitted from the T-BS 2 do not reach the MS 3. Such being the case, the MS 3, if the data such as the DL-MAP transmitted from the T-BS 2 is interrupted with the result of getting desynchronized with the T-BS 2, checks the elapse time of the timer since the notification of MOB_HO-IND has been given. The MS 3, if before the elapse time of the timer elapses over the RRT (170 msec), notifies the S-BS 2 of MOB_HO-IND (Cancel) defined as the information purporting the cancellation of the handover on the basis of the retained connection information of the S-BS (S604).

The S-BS 2 receiving the notification of MOB_HO-IND (Cancel) from the MS 3 records the event of canceling the handover in the HO history table 10 and resumes the communications with the MS 3 (S613). The S-BS 2 notified of the MOB_HO-IND (Cancel) as the connection event executes again the series of processes from step S501 onward described above, and carries out the process such as updating the RRT.

What has been described so far is the information flow between the MS 3 and the BS 2 when executing the handover after updating the RRT recorded in the RRT management table 11.

<Effects of Embodiment>

As discussed above, according to the present embodiment, the RRT is dynamically changed corresponding to the mobile state etc of the MS, whereby a capacity of the connection information temporarily retained when taking the handover can be reduced. Namely, the sufficient RRT is ensured for the MS continuing to move in the vicinity of the border of the cell of the BS 2 and requiring the elongated RRT, thereby enabling the highly-acceptable connection status without consuming a large quantity of system resources even if the handover is repeatedly cancelled. Another scheme that only the minimum RRT is ensured for the MS showing almost no movement and having no problem if the RRT is short, enables the system resources to be reduced.

<First Modified Example of Processing Flow>

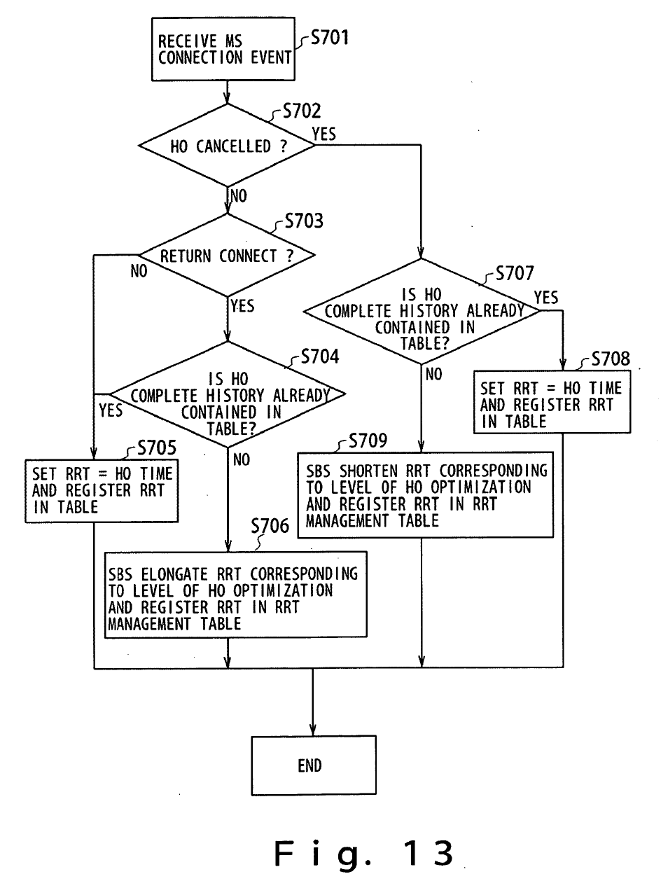

A modified example of the processing flow in the embodiment discussed above will be explained. The first modified example is that the RRT is corrected corresponding to a processing content of the handover. FIG. 13 shows an example of the processing flow of the BS 2 according to the first modified example. Note that the configuration is the same as in the embodiment discussed above.

When the network entry processing unit 6 accepts the connection event transmitted from the MS 3 (step S701) and when the HO processing unit 9 writes this connection event to the HO history table 10, the RRT management unit 8 acquires a content of the connection event written to the HO history table 10.

The RRT management unit 8 checks whether or not the connection event written to the HO history table 10 is the cancellation of the handover (step S702). The RRT management unit 8, if the connection event recorded in the HO history table 10 is the cancellation of the handover (the pattern 1) as specified in the second line of the table in FIG. 10, executes the processes from S707 onward. By Contrast, the RRT management unit 8, if the connection event recorded in the HO history table 10 is “INITIAL ENTRY Complete” (which is any one of the patterns 2-4) as specified in the fourth and seventh lines in the table in FIG. 10, executes the processes from S703 onward.

The RRT management unit 8, if the connection event recorded in the HO history table 10 is not the cancellation of the handover but “INITIAL ENTRY Complete”, checks whether or not this connection event is the return connection (i.e., the pattern 2) (step S703). Namely, the RRT management unit 8 refers to the HO history table 10 and thus searches for an event anterior to “INITIAL ENTRY Complete”. The RRT management unit 8, if the event anterior to the “INITIAL ENTRY Complete” event is the “HO Start” event and if there is no record of the event (HO Complete) purporting the completion of the handover between the “INITIAL ENTRY Complete” event and the “HO Start” event, determines that the “INITIAL ENTRY Complete” event is derived from the return connection (which is, i.e., the case of the pattern 2), and executes the processes from S706 onward. On the other hand, the RRT management unit 8, if there is the record of the “HO complete” event before the “INITIAL ENTRY Complete” event, determines that the connection event notified from the MS 3 is not derived from the return connection (i.e., the pattern 3 or 4), and executes the processes from S705 onward. The connection event notified from the MS 3 is not derived from the return connection, which connotes a case where, e.g., the MS 3, after temporarily taking the handover from the S-BS 2 to the T-BS 2, takes the handover again to the handover-source S-BS 2. In such a case, the “HO Complete” event is recorded in the HO history table 10, and hence the RRT management unit 8 searches for the record of this event when tracing the events related to the MS 3 (MS#3). Moreover, the RRT management unit 8, if there is no “HO Start” event anterior to the “INITIAL ENTRY Complete” event, determines that the connection is not the return connection (but the network connection). This scheme enables the RRT management unit 8 to detect whether or not the connection event notified from the MS 3 is derived from the return connection.

The RRT management unit 8, if the connection event notified from the MS 3 is derived from the return connection, checks whether there is a history of the previous handover of the MS 3 or not (step S704). Namely, the RRT management unit 8 checks by referring to the HO history table 10 whether or not there is the event of the completion of the handover (HO complete) about the MS 3. The RRT management unit 8, if there is the handover complete event about the MS 3 in the HO history table 10, executes the processes from step S705 onward. The RRT management unit 8, whereas if there is no handover complete event about the MS 3 in the HO history table 10, executes the processes from step S706 onward.

The RRT management unit 8, if the connection event notified from the MS 3 is not derived from the return connection and if there is the record of the event (HO Complete) purporting the completion of the handover in the HO history table 10, executes the following processes (step S705). To be specific, the RRT management unit 8 refers to the HO history table 10 and calculates a period of time till the handover is completed since the MS 3 (MS#3) has started the handover (i.e., the elapse time from the event specified in the fifth line to the event in the sixth line in the table in FIG. 10) (which is approximately 201 msec in the case of FIG. 10). The RRT management unit 8 sets the calculated elapse time as the RRTn and writes this RRTn as a new RRT value of the MS 3 (MS#3) to the RRT management table 11. The RRT management unit 8, if the “HO Start” event does not exist in the HO history table 10, sets the RRTn as the default value. With this operation, the RRT change process is completed.

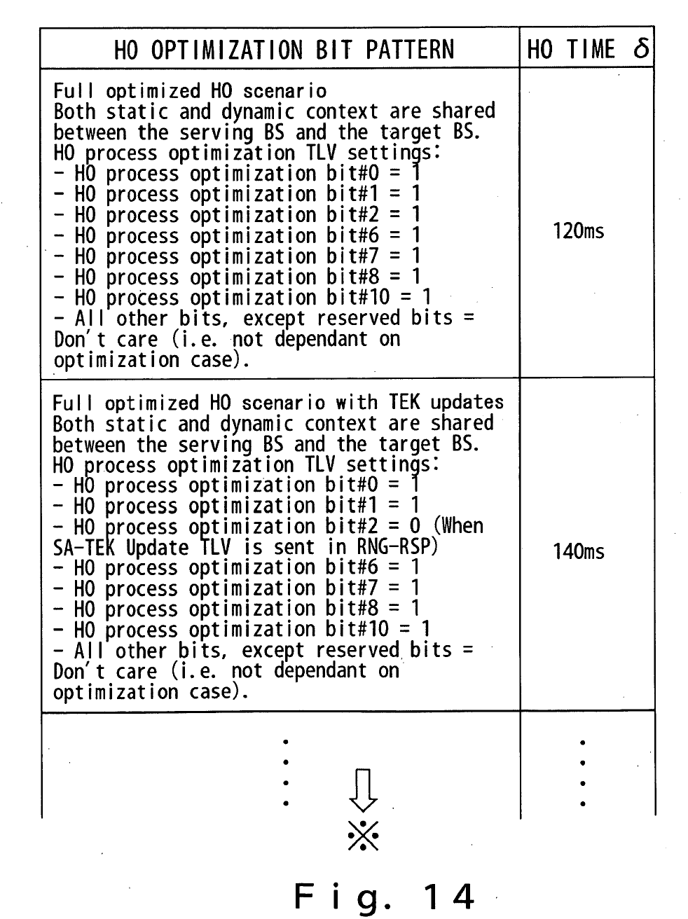

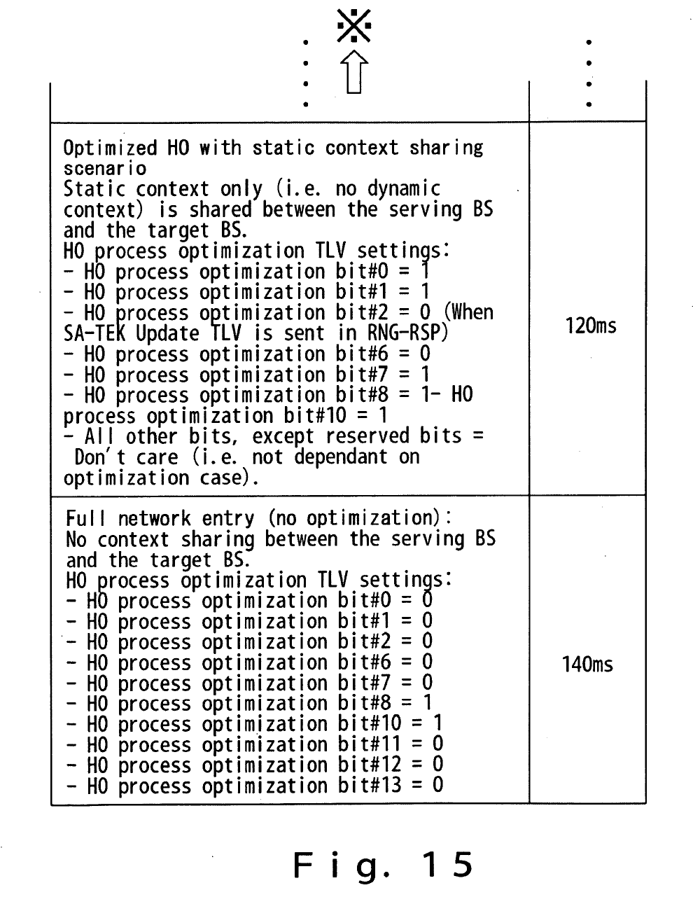

The RRT management unit 8, if the connection event notified from the MS 3 is derived from the return connection and if the “HO complete” event related to the MS 3 is not recorded in the HO history table 10, executes the following processes (step S706). In the same way as in the embodiment discussed above, let RRTi be the RRT before being corrected and RRTn be the RRT after being corrected. The RRT management unit 8, on the occasion of changing the RRT, estimates the handover time δ corresponding to a level of HO Optimization of the T-BS 2 to which the MS 3 tries to take the handover. FIGS. 14 and 15 show one table in which the time (δ) necessary for the handover process is displayed corresponding to every pattern of the HO Optimization. FIGS. 14 and 15 show a continuous table that is, it is assumed, previously stored in the RRT management unit 8. The RRT management unit 8 seeks out the handover time δ coincident with a bit pattern of the HO Optimization of the T-BS 2 to which the MS 3 tries to take the handover from the table in FIGS. 14 and 15, thereby estimating the handover time of the MS 3. The RRT management unit 8, if the sought-out handover time δ is larger than the RRTi recorded in the RRT management table 11 (i.e., RRTi<δ), corrects the RRTi. The RRT management unit 8, if the handover time δ is larger than the RRTi, sets a value obtained by multiplying the RRTi by 1.2 as the RRTn (i.e., RRTn=RRTi*1.2). Then, the RRT management unit 8 writes the calculated RRTn as a new RRT of the MS 3 to the RRT management table 11. For example, if the handover time δ us approximately 250 msec when the HO Optimization is based on Full network entry scenario, the RRT management unit 8 corrects the RRT related to the MS 3 (MS#2), because of being larger than the RRTi (=200 msec), to 240 msec (200 msec*1.2=240 msec), and writes the corrected RRT as the new RRT (that is, the RRTn) to the RRT management table 11. The contents of the RRT management table 11 after being changed are the same as those in FIG. 11 according to the embodiment described above.

On the other hand, the RRT management unit 8, if the connection event notified from the MS 3 is derived from the HO Cancel, checks whether there is the history of the handover of the MS 3 or not (step S707). Specifically, the RRT management unit 8 refers to the HO history table 10 and checks whether or not there is the previous event of the completion of the handover (HO Complete) with respect to the MS 3. The RRT management unit 8, if there is the record of the event of the completion of the handover with respect to the MS 3 in the HO history table 10, executes the processes from step S708 onward. While on the other hand, the RRT management unit 8, if there is not any event of the completion of the handover with respect to the MS 3 in the HO history table 10, executes the processes from step S709 onward.

The RRT management unit 8, if there is the record of the event (HO Complete) purporting the completion of the previous handover in the HO history table 10, changes the RRT of the MS 3 (step S708). Namely, the RRT management unit 8 refers to the HO history table 10 and calculates a period of time (approximately 201 msec) till the completion of the handover since the MS 3 (MS#3) has started the handover (i.e., the elapse time from the event specified in the fifth line to the event in the sixth line in the table in FIG. 10). The RRT management unit 8 sets the calculated elapse time as the RRTn and writes this RRTn as a new RRT value of the MS 3 (MS#3) to the RRT management table 11. The RRT change process is thereby completed.

The RRT management unit 8. if there is no record of the completion of the handover with respect to the MS 3 in the HO history table 10, executes the following processes (step S709). Specifically, the RRT management unit 8, in the same way as the process in step S706 described above, seeks out the handover time δ coincident with the bit pattern of the HO Optimization of the T-BS 2 from the table in FIGS. 14 and 15, thereby estimating the handover time of the MS 3. The RRT management unit 8, if a value obtained by adding the sought-out handover time δ to the threshold value tth is smaller than the RRTi recorded in the RRT management table 11 (i.e., RRTi>δ+tth), corrects the RRTi. The RRT management unit 8, if RRTi>δ+tth, sets a value obtained by multiplying RRTi by 0.85 as the RRTn (namely, RRTn=RRTi*0.85). Then, the RRT management unit 8 writes the calculated RRTn as a new RRT of the MS 3 to the RRT management table 11. For instance, if the HO Optimization is based on Full optimized HO scenario and if the handover time δ is on the order of 120 msec, a value obtained by adding the threshold value of 40 msec to 120 msec is smaller than the RRT of 200 msec notified to the MS 3, and hence the RRT management unit 8 corrects the RRT related to the MS 3 (MS#1) to 170 msec (200 msec*0.85=170 msec), and writes this value as a new RRT (i.e., RRTn) to the RRT management table 11. What has been described so far is the example of the processing flow of the BS 2.

According to the first modified example, in addition to the same effects as those in the embodiment discussed above, the handover time is estimated based on the pattern of the processing content of the handover, and it is therefore feasible to, even if the past results of the handovers were not recorded in the HO history table, correct the RRT to the more proper value.

<Second Modified Example of the Processing Flow>

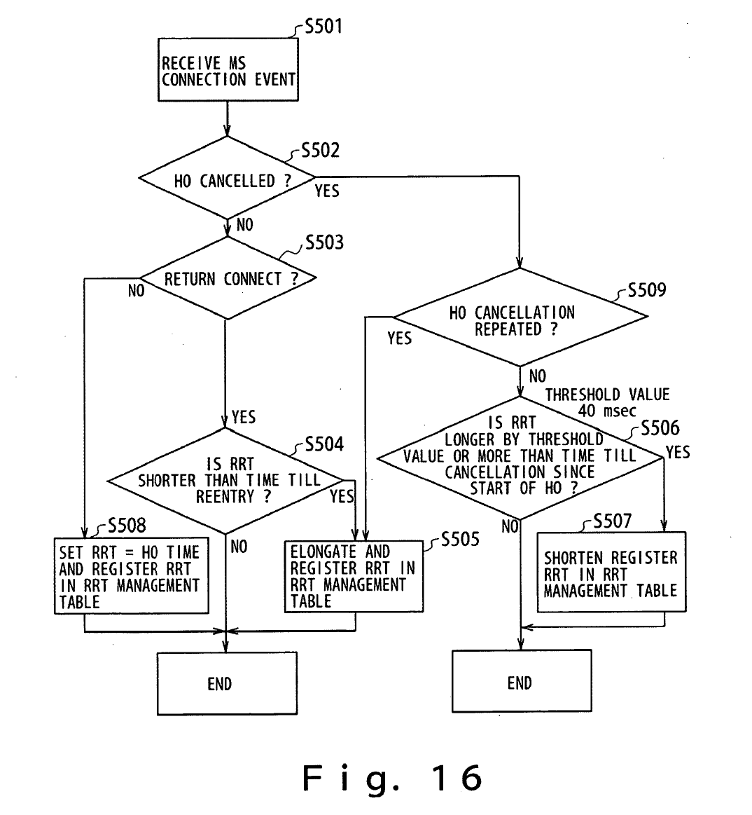

A (second) modified example of the processing flow in the embodiment discussed above will hereinafter be described. The second modified example is that the RRT is elongated when the handover repeatedly canceled. FIG. 16 shows an example of the processing flow of the BS 2 according to the second modified example. Note that the same processing contents as those in the embodiment discussed above are marked with the same symbols and numerals, and their explanations are omitted. Moreover, the configuration is the same as in the embodiment described above.

Steps S501 and S502 are the same as those in the embodiment discussed above (step S509). The RRT management unit 8, when detecting in step S502 that the connection event recorded in the HO history table 10 is the cancellation of the handover (i.e., the pattern 1), traces the records anterior to this connection event and checks whether the event of the cancellation of the handover is further recorded or not. The RRT management unit 8, if the plurality of connection events of the cancellations of the handovers is recorded in the HO history table 10, executes the processes from step S505 onward. The RRT management unit 8, if only one connection event of the cancellation of the handover is recorded in the HO history table 10, executes the processes from step S506 onward.

As described above, according to the second modified example, whether the MS 3 moves in the vicinity of the border of the cell or not can be checked from knowing whether the event of the cancellation of the handover is repeated or not. This scheme enables the RRT to be set longer, if it is desirable to retain the connection information of the handover source for a longer period of time because of the MS 3 continuing to move in the vicinity of the border of the cell of the BS 2. A short RRT is set in the MS 3 that does not need elongating the RRT, while a long RRT is set in the MS 3 that needs elongating the RRT, whereby the handover process friendly to the user can be realized while reducing the resources of the whole communication system.

<Third Modified Example of Processing Flow>

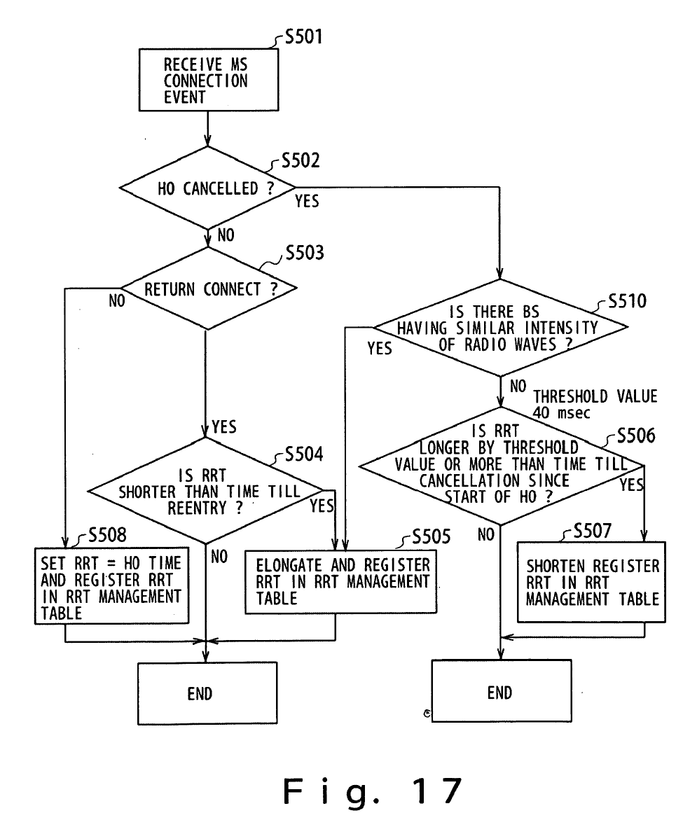

A (third) modified example of the processing flow in the embodiment described above will hereinafter be described. The third modified example is that the RRT is elongated if there exist the base stations BS 2 each having a similar intensity of the radio waves. FIG. 17 shows an example of the processing flow of the BS 2 according to the third modified example. Note that the same processing contents as those in the embodiment discussed above are marked with the same symbols and numerals, and their explanations are omitted. Moreover, the configuration is the same as in the embodiment described above.

Steps S501 and S502 are the same as those in the embodiment discussed above (step S509). The RRT management unit 8, when detecting in step S502 that the connection event recorded in the HO history table 10 is the cancellation of the handover (i.e., the pattern 1), acquires the information on the intensity of the radio waves of the BS 2, of which the MS 3 notifies via the air zone transmission/reception processing unit 5 etc. The information on the intensity of the radio waves is, when the MS 3 receives the radio waves transmitted from the BS 2, the information on the intensity of the radio waves measured and thus acquired by the scan processing unit 24. Normally, the radio waves of the plurality of base stations BS 2 reach the MS 3. Hence, the MS 3 notifies the RRT management unit 8 of the intensities of the radio waves of the plurality of base stations BS 2. The RRT management unit 8 compares the intensities of the radio waves of the plurality of base stations BS 2 with each other, thus determining whether there are the base stations BS having the similar intensities of the radio waves. This is because if there are two or more base stations BS having the similar intensities of the radio waves, the MS 3 is considered to reside in the vicinity of the border of the cell of the BS 2. The RRT management unit 8 compares the intensities of the radio waves of the plurality of base stations BS with each other, then, if there exists a combination of the base stations BS of which a difference therebetween falls within a range of a preset error (e.g., on the order or several %), determines that the base stations BS 2 having the similar intensities of the radio waves exist, and executes the processes from step S505 onward. While on the other hand, the RRT management unit 8 compares the intensities of the radio waves of the plurality of base stations BS with each other, and, if there exists none of combination of the base stations BS of which the difference therebetween falls within the range of the preset error, executes the processes from step S506 onward.

As described above, according to the third modified example, it is feasible to check by comparing the intensities of the radio waves whether the MS 3 moves in the vicinity of the border of the cell. This scheme enables the RRT to be set longer, if it is desirable to retain the connection information of the handover source for a longer period of time because of the MS 3 moving in the vicinity of the border of the cell of the BS 2. A short RRT is set in the MS 3 that does not need elongating the RRT, while a long RRT is set in the MS 3 that needs elongating the RRT, whereby the handover process friendly to the user can be realized while reducing the resources of the entire communication system.

<Fourth Modified Example of Processing Flow>

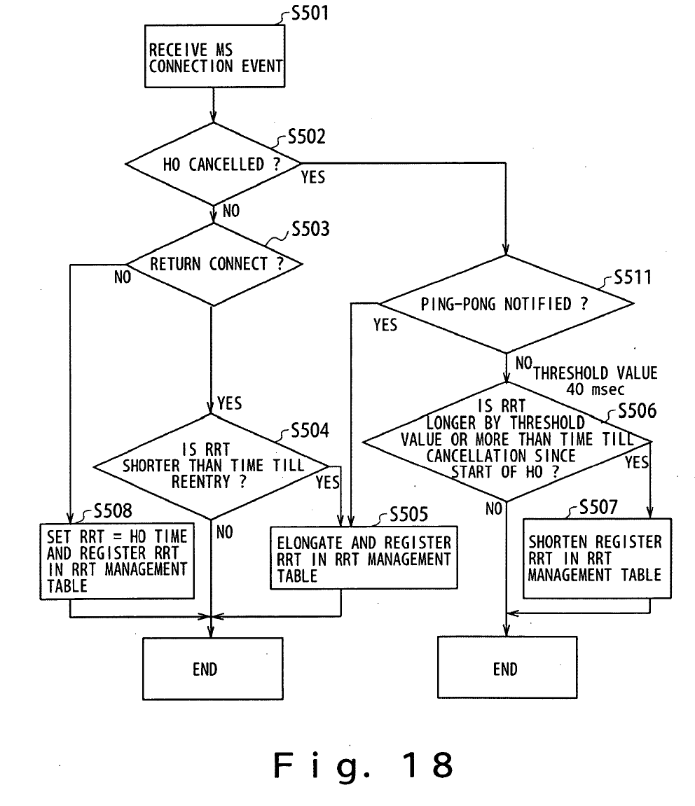

A (fourth) modified example of the processing flow in the embodiment discussed above will hereinafter be explained. The fourth modified example is that the RRT is elongated when the MS 3 notifies that the cancellation of the handover is repeated. FIG. 18 shows an example of the processing flow of the BS 2 according to the fourth modified example. Note that the same processing contents as those in the embodiment discussed above are marked with the same symbols and numerals, and their explanations are omitted. Moreover, the configuration is the same as in the embodiment described above.

Steps S501 and S502 are the same as those in the embodiment discussed above (step S510). The RRT management unit 8, when detecting in step S502 that the connection event recorded in the HO history table 10 is the cancellation of the handover (i.e., the pattern 1), acquires Ping-Pong information (which corresponds to predetermined information according to the present technology) of the BS 2, of which the MS 3 notifies via the air zone transmission/reception processing unit 5 etc. The Ping-Pong information is information generated by the MS 3 when the MS 3 moves in the vicinity of the border of the cell of the BS 2 and if the handover and the cancellation of the handover are repeatedly carried out, and is information of which the MS 3 notifies the BS 2. This Ping-Pong information is generated by the HO processing unit 23 and notified to the BS 2 via the air zone transmission/reception processing unit 21. The RRT management unit 8, when receiving the notification of the Ping-Pong information from the MS 3, executes the processes from step S505 onward. On the other hand, the RRT management unit 8, if unable to check the notification of the Ping-Pong information from the MS 3, executes the processes from step S506 onward.

As explained above, according to the fourth modified example, whether or not the MS 3 moves in the vicinity of the border of the cell can be checked from the notification given from the MS 3. This scheme enables the RRT to be set longer, if it is desirable to retain the connection information of the handover source for a longer period of time because of the MS 3 moving in the vicinity of the border of the cell of the BS 2. Namely, a short RRT is set in the MS 3 that does not need elongating the RRT, while a long RRT is set in the MS 3 that needs elongating the RRT, whereby the handover process friendly to the user can be realized while reducing the resources of the entire communication system.

Note that in the second through fourth modified examples, as exemplified by the first modified example, the RRT is estimated based on the processing content of the optimization process of the handover, and the RRT may be changed based on the estimated RRT. Namely. The second through fourth modified examples may be applied to the first modified example.

Moreover, in the embodiment and the modified examples discussed above, the RRT management unit 8 etc is installed in the interior of the BS 2 and the RRT change process is executed within the BS 2, however, another available configuration is that the RRT management unit 8 etc is installed within a host device (e.g., within the ASN-GW 4) of the BS 2, and the RRT change process is carried out in this host device. Further, the RRT may be corrected in a way that multiplies by a coefficient other than 1.2 and 0.85.

<Readable-by-Computer Recording Medium>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disc, a magneto-optic disc, a CD-ROM, a CD-R/W, a DVD, a DAT, an 8 mm tape, a memory card, etc are given as those removable from the computer.

Further, a hard disc, a ROM (Read-Only Memory), etc are given as the recording mediums fixed within the computer etc.

What is claimed is:

1. A communication control device applied to a wireless communication system which establishes a wireless communication between a base station and a mobile terminal, comprising:
a recording unit watching a handover process of the mobile terminal; and
a setting unit setting a period of retain time of connection information used when the mobile terminal reconnects to a handover source base station by abandoning the handover process,
wherein the recording unit, watches the handover process of the mobile terminal so as to record the connection event, and
the setting unit changes setting of the retain time, which is shared between the handover source base station and the mobile terminal, corresponding to connection event.

2. A communication control device according to claim 1, wherein if the mobile terminal tries to take the handover to a certain base station but fails to take the handover within the retain time and reconnects to the handover source base station, the setting unit elongates the retain time.

3. A communication control device according to claim 1, wherein the recording unit records the connection event containing an event of a start of the handover and an event of an interruption of the handover, and
the setting unit calculates elapse time from the event of the start of the handover up to the event of the interruption of the handover that are recorded by the recording unit, and, if the calculated elapse time is longer than the retain time, sets the retain time long.

4. A communication control device according to claim 1, wherein the recording unit records the connection event containing the event of the start of the handover and the event of the interruption of the handover, and
the setting unit calculates elapse time from the event of the start of the handover up to the event of the interruption of the handover that are recorded by the recording unit, and, if the calculated elapse time is shorter than the retain time, sets the retain time short.

5. A communication control device according to claim 1, wherein the recording unit records the connection event containing the event of the interruption of the handover, and
the setting unit, if the event of the interruption of the handover is repeatedly recorded in the recording unit, sets the retain time long.

6. A communication control device according to claim 1, wherein the setting unit compares intensities of radio waves transmitted to the mobile terminal from the plurality of base stations with each other, and, if there exist at least two or more radio waves having substantially the same intensity, sets the retain time long.

7. A communication control device according to claim 1, wherein the mobile terminal, if the event of the interruption of the handover is repeated, notifies the setting unit of predetermined information, and
the setting unit, when receiving the notification of the predetermined information from the mobile terminal, sets the retain time long.

8. A communication control device according to claim 1, wherein the setting unit changes the setting of the retain time, corresponding to a content of a registration procedure when the mobile terminal executes the handover process.

9. A communication control device according to claim 1, wherein the setting unit, if the mobile terminal interrupts the handover process and reconnects to the base station, starts the process of changing the setting of the retain time.

10. A communication control device according to claim 1, wherein the communication control device is installed in the base station or in a host device of the base station.

11. A communication control method executed by a communication control device applied to a wireless communication system which establishes a wireless communication between a base station and a mobile terminal, comprising:
recording a handover process of the mobile terminal; and
setting a period of retain time of connection information used when the mobile terminal reconnects to a handover source base station by abandoning the handover process;
watching, when recording the handover process of the mobile terminal so as to record the connection event; and
changing the retain time which is shared between the handover source base station and the mobile terminal corresponding to a communication status.

12. A communication control method according to claim 11, wherein if the mobile terminal tries to take the handover to a certain base station but fails to take the handover within the retain time and reconnects to the handover source base station, the retain time is elongated.

13. A communication control method according to claim 11, wherein when recording the connection event, the connection event containing an event of a start of the handover and an event of an interruption of the handover is recorded, and
when setting the retain time, there is calculated elapse time from the event of the start of the handover up to the event of the interruption of the handover that are recorded by the recording unit, and, if the calculated elapse time is longer than the retain time, the retain time is set long.

14. A communication control method according to claim 11, wherein when recording the connection event, the connection event containing an event of a start of the handover and an event of an interruption of the handover is recorded, and
when setting the retain time, there is calculated elapse time from the event of the start of the handover up to the event of the interruption of the handover that are recorded by the recording unit, and, if the calculated elapse time is shorter than the retain time, the retain time is set short.

15. A communication control method according to claim 11, wherein when recording the connection event, the connection event containing the event of the interruption of the handover is recorded, and
when setting the retain time, if the event of the interruption of the handover is repeatedly recorded in the recording unit, the retain time is set long.

16. A communication control method according to claim 11, wherein when setting the retain time, intensities of radio waves transmitted to the mobile terminal from the plurality of base stations are compared with each other, and, if there exist at least two or more radio waves having substantially the same intensity, the retain time is set long.

17. A communication control method according to claim 11, wherein the mobile terminal, if the event of the interruption of the handover is repeated, notifies of predetermined information, and
when receiving the notification of the predetermined information from the mobile terminal, the retain time is set long.

18. A communication control method according to claim 11, wherein when setting the retain time, there is changed the setting of the retain time, corresponding to a content of a registration procedure when the mobile terminal executes the handover process.

19. A communication control method according to claim 11, wherein if the mobile terminal interrupts the handover process and reconnects to the base station, the process of changing the setting of the retain time is started.

20. A communication control method according to claim 11, wherein the communication control method is executed by the base station or by a host device of the base station.
